(19) United States
(12) Patent Application Publication
(10) Pub. No.: US 2018/0252087 A1
(43) Pub. Date: Sep. 6, 2018

(54) A METHOD AND A SYSTEM FOR PERFORMING CHEMICAL TREATMENT OF A NEAR WELLBORE AREA

(71) Applicants: SCHLUMBERGER TECHNOLOGY CORPORATION, Sugar Land, TX (US); SCHLUMBERGER CANADA LIMITED, Calgary (CA)

(72) Inventors: Oleg Yuryevich DINARIEV, Moscow (RU); Nikolay Vyacheslavovich EVSEEV, Moscow (RU); Murtaza ZIAUDDIN, Katy, TX (US); Sergey Sergeevich SAFONOV, Moscow (RU); Anna Vyacheslavovna BELETSKAYA, Moscow (RU); Denis Vladimirovich KLEMIN, Houston, TX (US); Dmitry Anatolievich KOROTEEV, Moscow (RU)

(21) Appl. No.: 15/562,306

(22) PCT Filed: Mar. 27, 2015
(86) PCT No.: PCT/RU2015/000194

§ 371 Date: Sep. 27, 2017

(51) Int. Cl. E21B 43/28; G06T 15/08; E21B 43/25; E21B 43/16

(52) U.S. Cl. CPC E21B 43/28; G06T 15/08; G06T 17/05; E21B 43/162; E21B 43/25

(57) ABSTRACT

Performing of a chemical treatment of a near wellbore area may include extraction of a core sample representing a portion of a near wellbore area, obtaining a three-dimensional (3D) pore scale model of a core sample, determination of composition of a core sample, generation scenarios of chemical treatment that each include chemical agent, determination of rates of reaction between mineral comprising core sample and treatment fluids, determination of qualitative and quantitative composition of reaction system in equilibrium, simulation of chemical treatment process using 3D model of a core sample and data on chemical reactions between minerals and treatment fluids, analysis of the chemical treatment influence on transport properties of a core sample, selection of optimal treatment scenario. Further, an operation is performed using the selected treatment scenario.

### FIELD OF THE INVENTION

This disclosure relates generally to the field of chemical treatment of hydrocarbon producing wells. More specifically, the disclosure relates to methods for performing chemical treatment involving injection of chemicals into a well.

### BACKGROUND OF THE INVENTION

Properties of a near wellbore area largely determine performance of a particular well, specifically a rate of hydrocarbon recovery and well operation costs. A term “properties of a near wellbore area” refers in this application to porosity and permeability of a near wellbore area. The properties of a near wellbore area can be altered by but not limited to drilling and completion fluids, precipitation products and fines migrating from a formation to a borehole. Modification of the properties of a near wellbore area can be required on a stage of starting of well operation as well as during well operation. One of approaches to modify the properties of a near wellbore area is based on injection of treatment fluids with chemically reactive agents to a well. Chemistry of oil bearing rock, damage and reservoir fluids can be too complex and hence the choice of a treatment fluid in each particular case is far from obvious. Terms “acid treatment”, “acidizing” and “matrix treatment” can be used interchangeably in this invention and refer to a stimulation technique based on injection of solution of acid or acid mixtures to a near wellbore area. Such a technique influences on the properties of a near wellbore area by means of dissolution of a rock and/or damage or precipitation of products resulted from interaction between the treatment fluid and constituents of the near wellbore area (rock minerals, damage, hydrocarbons etc.).

In spite of progress achieved in acidizing technique there are still a lot of uncertainties regarding influence of treatment fluids on the properties of a near wellbore area. To minimize a risk to reduce the efficiency of a well, the matrix treatment should be accurately optimized for a particular well. For this purpose laboratory experiments such as solubility tests, petrographic and petrophysic studies and core flow tests are generally used (see, for example, H. O. McLeod. Matrix Acidizing, Journal of Petroleum Technology, 1984, pp. 2055-2069).

The solubility tests are performed to evaluate an amount of minerals dissolved by an acid. The petrographic study is conducted to determine a mineralogy of a rock, cementing minerals and clay fines, porosity types, grain size and location of pores. The petrophysic studies involve determination of porosity and permeability of a rock. The core flow tests performed under reservoir pressure temperature conditions are required to evaluate the effects of fluids injected into sandstone formations. Significant drawback of such an approach is that laboratory tests are destructive, which means that tests cannot be repeated on the same rock sample under the same condition.

Alternative approach involves the use of modeling the effect of the matrix treatment (see, for example, S. Ali et al., Virtual Testing: The Key to Stimulating Process, Oilfield Review, 2004, v. 16, pp. 58-68). Such simulators provide modeling of chemical reactions and indication of the amount of dissolution and precipitation of mineral species. However modeling is performed on a macroscale and information about the structure of pores and distribution of the minerals enters the model as a set of effective cumulative parameters.

It should be noted that performance of the matrix treatment is significantly determined by nano- and microscale properties of a rock, by location of minerals relative to a path of injected fluid and of course, by compatibility of treatment fluids with reservoir fluids. These aspects should be taken into account in the procedure of matrix treatment optimization.

The claimed method provides faster turnaround time as compared to comprehensive laboratory studies. This makes it possible to consider wider variety of options at optimization stage and increase the accuracy of selection. The method also provides preservation of the artificial three-dimensional model; i.e., multiple numerical experiments can be done on exactly the same sample. In contrast to working with real chemistry, health, safety and environment issues are not a problem. Besides, there are smaller uncertainties in selection of fluids for single or multistage treatment.

### SUMMARY OF THE INVENTION

In general, embodiments relate to performing a near wellbore area chemical treatment. A core sample consisting of rock minerals is extracted from at least one portion of the near wellbore area. A three-dimensional (3D) porous solid image of the extracted core sample is obtained and a 3D pore scale model describing a pore space of the extracted core sample is generated from the obtained 3D porous solid image. The, a mineral composition of the extracted core sample is determined.

Transport properties of the extracted core sample are calculated by performing simulation of a non-reactive fluid flow through the pore space of the extracted core sample using the generated 3D pore scale model.

A plurality of scenarios of the chemical treatment of the at least one portion of the near wellbore area are generated, each scenario providing for injection of at least one treatment fluid comprising at least one chemical agent.

For each scenario of the chemical treatment rates of chemical reactions between the rock minerals of the extracted core sample and the chemical agents of the treatment fluids and quantitative and qualitative compositions of a reaction system in equilibrium are defined.

For each scenario of the chemical treatment simulation of a reactive fluid flow through the pore space of the core sample is performed using the generated 3D pore scale model, the defined rates of the chemical reactions between the rock minerals of the extracted core sample and the chemical agents of the treatment fluids and the defined quantitative and qualitative compositions of the reaction system in equilibrium. A modified 3D pore scale model is generated for each scenario of the chemical treatment of the at least one portion of the near wellbore area, wherein each modified 3D pore scale model describes a pore space of the extracted core sample after the chemical treatment.

Transport properties of the extracted core sample after the chemical treatment are calculated for each scenario of the chemical treatment of the at least one portion of the near wellbore area by performing simulation of a non-reactive fluid flow through the pore space of the core sample after the chemical treatment using the generated modified 3D pore scale models.

The calculated transport properties of the extracted core sample and the calculated transport properties of the extracted core sample after the chemical treatment are compared for each scenario of the chemical treatment of the at least one portion of the near wellbore area. A scenario of the chemical treatment is selected providing specified porosity, permeability and relative permeability of the core sample after the chemical treatment and the chemical treatment of the at least one portion of the near wellbore area is performed using the selected scenario of the chemical treatment.

### BRIEF DESCRIPTION OF DRAWINGS

FIG. 1 shows a flowchart in accordance with one or more embodiments.

FIG. 2 shows an example of modeling of hydrochloric acid solution flow through a porous structure of a small digital rock model.

FIG. 3 shows an example diagram in accordance with one or more embodiments.

FIG. 4 shows a computing system in accordance with one or more embodiments

### DETAILED DESCRIPTION OF THE INVENTION

Specific embodiments will now be described in detail with reference to the accompanying figures.

In the following detailed description of one or more embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complication of the description.

In general, embodiments provide a method and system for analyzing multiple chemical agents on a single core sample or set of core samples with regard to its application for chemical treatment of a near wellbore area.

Chemical treatment of a near wellbore area, as used in this application, refers to a technique improving the performance of a particular well. Fluids can be injected to a production well or an injection well.

Chemical well treatment affects the near wellbore zone. It is applied to achieve:
a) Increase of local permeability
b) Modification of local relative permeability
c) Decrease of watercut
d) Modification of injectivity
   The injected fluids intended for chemical treatment of a well may include any chemical agent, such as acids, bases, polymers, fibers, surfactants and combinations of different chemical agents. Mixtures for matrix treatment may be comprised by but not limited to water, hydrochloric acid, formic acid, acetic acid, NH₄HF₂, ammonia, EDTA, boron hydroxide.

The efficacy of the chemical treatment of a well in increase of efficiency of well performance depends on careful planning of the injection schedules such as the selection of fluid, the determination of the composition of the fluid, the pumping rate, the switching cycles between different injected fluid, etc. A chemical treatment scenario should be determined considering geological and geo-physical information, such as temperature, pressure, porosity, permeability, composition of matrix rock, damage and reservoir fluids, etc.

Specifically, one or more embodiments obtain scenarios of chemical treatment of portions of a near wellbore area and a global scenario of chemical treatment of the whole near wellbore area.

Each scenario of chemical treatment of a near wellbore area implies injection of treatment fluids with a chemical agent or mixtures of chemical agents to the near wellbore area. Each scenario of chemical treatment of a portion of a near wellbore area can be single stage or multistage. Multistage scenario includes subsequent injection of different chemical agents or mixtures of chemical agents.

Each scenario is characterized by:
1. A number of stages of the treatment
2. Composition of treatment fluids intended for injection to a portion of the near wellbore area
3. Sequence of injection of treatment fluids (if a chemical treatment scenario is multistage)
4. Volumes of treatment fluids injected on each stage
5. Rate of fluid injection on each stage
6. Shut in time on each stage.

In one or more embodiments, the same chemical treatment scenario can be applied to the whole near wellbore area subjected for chemical treatment. In other embodiments, the near wellbore area, for example if its properties are characterized by high heterogeneity, is divided to several portions and for each portion or set of portions a particular scenario is applied. Hence the global scenario of chemical treatment of the near wellbore area is comprised of one or more scenarios.

Planning of chemical treatment of a near well bore area involves study of different chemical reactions. A chemical reaction is a process that leads to the transformation of one set of chemical substances to another. Selection of treatment fluids potentially applied for treatment of a near wellbore area in each scenario is based on evaluation of compatibility of treatment and reservoir fluids, on impact of the treatment fluids on damage constituents and rock minerals, and evaluation of corrosive stability of well tubular toward treating mixture. Treatment fluids can be selected among mixtures already optimized for similar candidates. It is also possible to modify optimized treatment fluids or to design the new one. Two ways are possible to evaluate the performance of treatment fluids: numerical modelling and laboratory experiments. Combination of modern methods of computational chemistry allows proper screening of efficiency of treating fluids by means of modelling of phenomena important from the view of optimization of chemical treatment of a near wellbore area such as physical adsorption and/or chemisorption of mineral acids, bases, salts, organometallic complexes and surfactants on a solid surface, ion exchange reactions between electrolytes in solution and between an electrolyte in solution and mineral on a rock surface, as well as proton transfer reactions, homogeneous catalytic processes in liquid phase and heterogeneous catalytic reactions in liquid-solid interphase. Such an approach allows accounting for dissolution and precipitation of rock minerals and damage constituents, gas evaluation, formation of emulsions as well as formation of thin films on solid surfaces. Significant advantages is that following this way it is possible to identify mineral surface active sites toward adsorption/activation of treating fluid, building up structure-reactivity relationship and to establish mechanism of the reaction, which is important in designing of new mixtures. Modeling of processes mentioned above can be done based on experimentally obtained data and within quantum chemistry, molecular dynamic methods, Monte-Carlo approach.

Analysis of efficacy of each scenario for chemical treatment of a near wellbore area is performed with the use of core samples.

A core sample, as used in this application, refers to a 3D porous medium representing a portion of a near wellbore area. In particular, a core sample refers to a physical sample obtained from a portion of the near wellbore area. For example, a core sample may be obtained by drilling into a portion of the near wellbore area with a core drill to extract the core sample from the near wellbore area. In one or more embodiments, analysis of the seismic data and/or information related to porosity, saturation, permeability, etc detected by various survey tools and/or data acquisition tools is performed to determine core sample or set of core samples representing properties of the near wellbore area. From the core sample, a three-dimensional (3D) porous solid image of the core sample is obtained. The 3D porous solid image is used to generate a pore scale model showing realistic 3D geometry of pore-grain structure within the sample. If multiple core samples are used, each core sample may have a unique associated 3D porous solid image of the core sample and a unique associated 3D pore scale model of the core sample.

Using the pore scale model, simulations are performed following different scenario of chemical treatment at high-pressure high-temperature conditions to identify the optimal scenario of chemical treatment of a portion or entire near wellbore area.

Prediction of chemically reactive mixture influence on transport properties of porous media involves study of chemical reactions between minerals constituting the core sample and treatment fluids. Reaction occurs until the concentration of the products and reactants are unchanged over time, in other words, until the reaction system reaches equilibrium state. The term “reaction system” in this invention refers to individual substances or mixture of substances, separated from surrounding by real or imaginary interface. The term “reactant” refers to a substance initially involved in a chemical reaction. The term “product” refers to any species generated by means of a chemical reaction. While the term “species” in this invention refers to atoms, molecules, molecular fragments, ions, etc. subjected to chemical process or to measurements.

Important characteristic of chemical reaction is a reaction rate. The reaction rate defines a rate at which concentration changes as the system approaches equilibrium. The rates at which reactions proceed are given by rate laws. A rate law reflects our idea of how a reaction proceeds on a molecular scale and, in fact, quantify the slowest or “rate-limiting” step in a hypothesized reaction mechanism. Different reaction mechanisms can predominate in fluids of different composition, since species in solution can serve to promote or inhibit the reaction mechanism. For this reason, there may be a number of valid rate laws that describe the reaction of a single mineral.

It is considered that dissolution and precipitation proceeds in five steps:
1) diffusion of reactants from a bulk fluid to a mineral surface
2) adsorption of reactants onto reactive sites
3) a chemical reaction involving breaking and creation of bonds
4) desorption of reaction products
5) diffusion of the products from the mineral surface to the bulk fluid

The adsorption and desorption processes are almost certainly rapid, so two classes of rate-limiting steps are possible. If the reaction rate depends on how quickly reactants can reach the surface by aqueous diffusion and the products can move away from it the reaction is said to be “transport controlled”. If the speed of surface reaction controls the rate, the reaction is termed “surface controlled”.

Different approaches can be used for the design of matrix treatment such as lumped mineral, equilibrium approximation, partial equilibrium models. In lumped mineral approach a complex mineralogy is lumped into characteristic minerals and an average reaction rate for these minerals is determined from core tests. In the equilibrium approach it is assumed that reactions are much faster than a contact time of minerals with acids. The partial equilibrium approach combines the equilibrium approaches and data on chemical reaction rate. Slow reactions are modeled using chemical reaction law and the equilibrium model is used for fast reactions. Complex chemical reaction between minerals and treatment fluids can be formulated in terms of pseudo components that must be chosen to reduce the amount of components taken into account in chemical treatment design and to meet the requirements of the acid treatment impact analysis. The term “pseudo reaction” in this invention refers to a summarized reaction in which a reactant and products are represented as pseudo components.

Using a pore scale model as well as data on chemical reaction rate and a composition (quantitative and qualitative) of a system in equilibrium, simulations of treatment fluid flow at high-pressure high-temperature conditions can be performed to identify an optimal scenario of chemical treatment of a portion of a near wellbore area or a global scenario of chemical treatment of entire near wellbore area. The term “composition” in this invention if not specified refers to quantitative and qualitative composition.

There is a wide scope of methods traditionally used in modeling of multiphase hydrodynamics. But we suggest to use a density functional method (DFM) applied for hydrodynamics (see for example Demianov A. Yu., Dinariev O. Yu., Evseev N. V. Introduction to the Density Functional Method in Hydrodynamics, Fizmatlit, Moscow, 2014, 328 p.). In contrast to the traditional methods, of multiphase hydrodynamics, DFM does not require explicit definition of the phases. Instead, configuration of phases is reconstructed from the calculated distribution of chemical components molar densities, which are the primary variables along with the mass velocity. This approach enables direct simulation of complex compositional multiphase flows with phase transitions and chemical reactions, both homogeneous and heterogeneous.

Method described below, may be used to model a chemical treatment of a near wellbore area using a modeling tool.

The chemical treatment modeling tool may include hardware, software or combination of both. The hardware may include a core sample scanner configured to generate a 3D porous solid image from a core sample, computer processor and memory.

In one or more embodiments, the software may include an interface, an image generator, a 3D pore scale model generator, a chemical reaction simulator, a chemical treatment simulator, a non-reactive fluid flow simulator and an image generator. The software components may execute on the computer processor and use the memory.

The interface may include a user interface and/or an application programming interface (API). The interface includes functionality to receive input and transmit output, such as to display. For example, the input may be the 3D porous solid image of one or more core samples, scenarios of chemical treatment of near wellbore area, and other information. The output may correspond to graphical representation of simulation results on the display, commands to send to the wellsite for controlling performance of a well, and other output.

The 3D pore scale model generator corresponds to software that includes functionality to generate a 3D pore scale model from the 3D porous solid image. The 3D pore scale model describes the core sample. Specifically, whereas the 3D porous solid image may show the physical structure of the core sample, the 3D pore scale model may include the lithology of the core sample. For example, lithographic properties of the core sample may include a pore size distribution, a rock type, tortuosity measurements, statistical results generated from the properties, and other information.

The chemical reaction simulator includes functionality to model chemical reactions, to identify a rate at which concentration of products and reactants changes as the system approaches equilibrium as well as concentrations of the species in equilibrium at specified conditions. In one or more embodiments, the chemical reaction simulator contains large databases on thermodynamic data of minerals, treatment fluids and species, generating by means of reaction between minerals and treatment fluids. In one or more embodiments the chemical reaction simulator includes functionality to represent reactions in terms of pseudo components and to identify the stoichiometric coefficients of the pseudo reaction, a rate law as well as parameters of rate low for pseudo reaction at specific pressure and temperature.

In one or more embodiments, the 3D pore scale model generator as well as chemical reactions simulator are connected to the chemical treatment simulator. The chemical treatment simulator includes functionality to simulate injection of one or more treatment, fluids with chemical agents into a portion of a near wellbore area using the 3D pore scale model and chemical reaction data. The chemical treatment simulator may include functionality to simulate the injection directly to the 3D pore scale model or to a region model for the entire the portion of the near wellbore area. Specifically, the chemical treatment simulator may include functionality to generate the region model using the 3D pore scale model and simulate the injection operation on the region model. In one or more embodiments, the output of chemical treatment simulation is 3D pore scale models or the region model of modified porous media.

In one or more embodiments, the 3D pore scale model generator and the chemical treatment simulator are connected to the non-reactive fluid flow simulator to evaluate the impact of treatment fluids on transport properties of porous media. The non-reactive fluid flow simulator may include functionality to simulate injection of fluid directly to the 3D pore scale model or to the region model for the entire portion of the near wellbore area and to modified 3D pore scale model or region models generated after simulation of treatment process.

In one or more embodiments, the image generator includes functionality to generate two dimensional (2D) and/or (3D) images from the simulation results. For example, the image generator may include functionality to generate images showing the injection operation through the 3D pore scale model.

The various components of chemical treatment of a near wellbore area modeling tool may include functionality to store and retrieve data from data repository. In one or more embodiments, the data repository is any type of storage unit and/or device (e.g., a file system, database, collection of tables, or any other storage mechanism) for storing data. Further, the data repository may include multiple different storage units and/or devices. The multiple different storage units and/or devices may or may not be of the same type or located at the same physical site. The data repository includes functionality to store one or more 3D porous solid images, one or more 3D pore scale models, thermodynamic properties of minerals, constituents of chemical treatment fluids and species resulting from interaction between minerals and treatment fluids, scenarios of chemical treatment of near wellbore scenarios, and simulation results.

In one or more embodiments, simulation results are results of performing one or more simulations. For example, the simulation results may define an optimal chemical agent and/or global chemical treatment scenario. Further, the simulation results may include information about the simulation, such as expected gross and net revenue, costs, time, information describing the lithographic results of the injection operation (e.g., effect on near wellbore area) using the chemical agent, and/or other results.

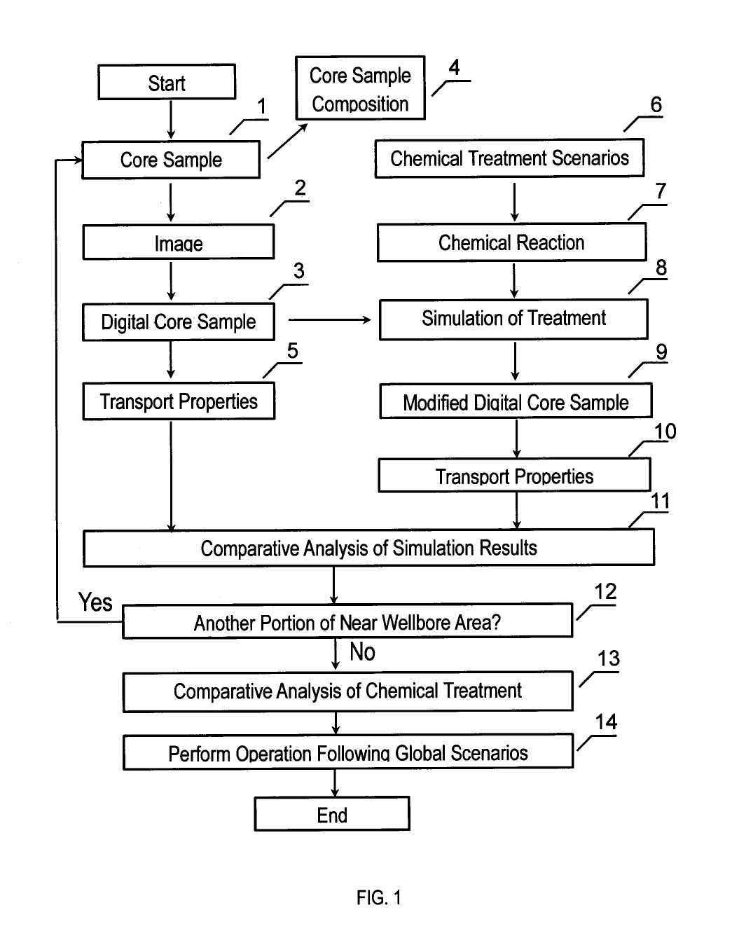

FIG. 1 shows a flowchart in accordance with one or more embodiments.

In Block 1 a core sample consisting of rock minerals is extracted from a portion of a near wellbore area.

In Block 2, a 3D porous solid image of the core sample is obtained in accordance with one or more embodiments. Obtaining the 3D porous solid image may be accomplished by scanning the core sample. For example, X-ray micro tomography, 3D nuclear magnetic resonance (NMR) imaging, 3D reconstruction from petrographic thin-section analysis and confocal microscopy, 3D reconstruction from analysis of 2D element maps acquired by Scanning-Electron Microscopy (SEM) with energy-dispersive X-ray spectroscopy (EDX) function, or other technique or combination of techniques may be used to obtain the 3D porous solid image.

In Block 3, a 3D pore scale model is generated from the 3D porous solid image. To obtain the 3D pore scale model, digital processing and morphological analysis of the 3D porous solid image may be performed. Specifically, consecutive application of image filtering, segmentation and multiple property recognition may be used to obtain a digital 3D model of 3D porous solid image. Morphological and geometrical statistical property analysis may further be performed to obtain information, such as pore size distribution, local and average tortuosity measurement, grain size distribution, and other properties of the core sample.

In Block 4, a mineral composition of the extracted core sample is determined. The mineral composition of the extracted core sample in one or, more embodiments is identified by X-ray diffraction or in the Block 2 by Scanning-Electron Microscopy (SEM) with energy-dispersive X-ray spectroscopy (EDX) function.

In Block 5, transport properties of the extracted core sample are calculated by performing simulation of a non-reactive fluid flow through the pore space of the extracted core sample using the generated 3D pore scale model. In one or more embodiments transport properties are studied in the framework of density functional theory applied for hydrodynamics (DFH).

In Block 6, chemical treatment scenarios, each specifying a composition of treatment fluids, a number of stages (if a treatment scenario is multistage), a sequence of the treatment fluids intended for injection (if a treatment scenario is multistage), volume of each treatment fluid injected and a rate of each fluid injection, a shut in time at each stage are obtained. For example, using the user interface and for each chemical treatment scenario, the user may enter or select the name of the each chemical agent and any other parameters for chemical treatment scenario. In the example, the chemical treatment modeling system includes or is able to obtain from a third party system properties of chemical agent, such as viscosity and other properties. Thus, the user does not need to provide such properties.

In Block 7, rates of chemical reactions between the rock minerals of the extracted core sample and the treatment fluids and a composition (quantitative and qualitative) of a reaction system in equilibrium state are determined.

Reactions occur until the system reaches equilibrium. The reaction system is in chemical equilibrium when concentration of the products and reactants are unchanged over time. The composition of the system can be directly determined from the experiment. A quantitative composition of the reaction system or concentrations of species in the reaction system can be calculated using thermodynamic data of the species involved to reaction such as heat capacity, standard heat of formation, standard free energy of formation, standard entropy of formation. Required thermodynamic data are stored in databases and introduced to a chemical reaction modeling tool.

A reaction rate defines how fast or slow the reaction system reaches the equilibrium state. The rates at which the reactions proceed are given by rate laws. Required data on chemical reaction can be found in literature, databases. The rate laws and rate law parameters such as order or specific constant of chemical reaction can be determined from analysis of experimentally obtained concentration-time data by standard methods such as the differential method, the integral method and nonlinear regression (least-squares analysis) (see for example, H. S. Fogler. Essentials of Chemical Reaction Engineering. Prentice Hall. 2011. 707 p). Concentration-time data can be obtained using for example a batch reactor or a differential reactor.

Detailed chemistry model for a reactive flow system applicable for modeling of chemical treatment requires several 10s of minerals and fluid species. Taking into account such a big number of components poses a, big load on computational resources while running the reactive flow scenarios in Block 8. A possible approach to alleviate this issue while not losing the sensitivity of the target scenario simulation is based on reformulating the reactants/products and chemical reaction in terms of pseudo components and pseudo reaction. Rate law of the pseudo reaction as well as stoichiometry of pseudo reaction can be identified using chemical reaction modeling tool.

Determination of the composition of the reaction system in equilibrium and the rate of the reaction is needed for prediction of amount and location of minerals dissolved when a reactive fluid flows through porous media.

In Block 8, simulation of a reactive fluid flow through the pore space of the core sample using the generated 3D pore scale model, the defined rate of the reactions between the rock minerals of the extracted core sample and the chemical agents of the treatment fluids and the defined quantitative and qualitative composition of the reaction system in equilibrium is performed. In one or more embodiments, simulation can be performed by density functional theory applied for hydrodynamics. The method combines continuum fluid mechanics and thermodynamics principles and accounts for mass, momentum and energy balance with a diffuse interface description of transition zones. The DHD framework enables modeling of fluid-fluid and fluid-solid interfacial tensions, moving contact lines and dynamic changes of topology of interfaces, wettability and adsorption, phase transitions and chemical reactions. The fluid phase behavior is characterized (described) by a thermodynamic model that allows for arbitrary compositional changes. That makes it possible to account for change of fluid composition caused by chemical treatment.

The starting point of density functional approach in hydrodynamics is the assumption that the entropy of the mixture is the functional depending on certain set of basic fields such as molar densities of species nᵢ, mass velocity vₐ, and internal energy density u. In practice, it is convenient to use some model expression for the functional, which can be considered as approximation to the exact functional for certain set of problems:

$$\begin{matrix}{S}_{D} = {S}_{D} [ u , {n}_{i} ] = {\int }_{D} s ( u , {n}_{i} ) dV + {\int }_{\partial D} S \cdot dA + {S}_{D} \cdot [ {n}_{i} ] , & ( 1 ) \\ {S}_{D} \cdot [ {n}_{i} ] = - {2}^{- 1} {α}_{ij} ( {n}_{k} ) {\partial }_{a} {n}_{i} {\partial }_{a} {n}_{j} , & ( 2 )\end{matrix}$$

where ∂D is a boundary surface for the region D, s=(u,nᵢ,ε_{ab}) is an entropy bulk density for a homogeneous mixture, αᵢⱼ is a positive-definite symmetric matrix, s*=s*(u,nᵢ) is an entropy surface density (not equals to zero if ∂D is a contact surface with some immobile solid). S_{D*}[nᵢ] is some auxiliary functional dependent on densities nᵢ only, which becomes zero for homogeneous density fields (nᵢ=const).

The critical points of the functional given by Eq. (2) with a given internal energy of a mixture U_{D} and given number of particles of each of the components N_{iD} in the domain D determines the stationary equilibrium states of a mixture. Equilibrium conditions and hydrodynamics of both non-reactive and reactive mixtures are discussed in (Demianov A. Yu., Dinariev O. Yu., Evseev N. V. Introduction to the Density Functional Method in Hydrodynamics. Fizmatlit. Moscow. 2014. 328 p). Here we focus just on the characterization of reactive mixture.

Let us at first consider chemical reactions:

ϕ_{Ii}Cᵢ [symbol] ϕ′_{Ii}Cᵢ, (3)

where index I (I=1, . . . , K) corresponds to the chemical reaction numbers, Cⱼ and Cᵢ, which represent reactant and product component correspondingly, while vᵢ and vⱼ are nonnegative stoichiometric coefficients. Because the total amounts of components are not conserved, it is convenient to introduce a set of the following numbers:

η_{Ii}=ϕ_{Ii}−ϕ′_{Ii} (4)

It is suitable to interpret these numbers as a set of k vectors in m-dimensional space. Let us select the basis ζ_{Ii} of K₁ vectors in the orthogonal complementary subspace to the vectors η_{Ii}. Conservation of the set of K₁ quantities resulting from the balance conditions for the chemical reactions (3) is described by the following equation:

Z_{JD}= [symbol] _{Ji}N_{iD}. (5)

Then the equilibrium states of a mixture must satisfy the variational equation as follows:

δS_{D}−λ₀δU_{D}−λ_{J}δZ_{JD}=0 (6)

where λ₀, λ_{J} are Lagrangian multipliers.

After the transition from (6) to variational derivatives the following equilibrium conditions can be obtained:

Θ₀=λ₀, (7)

Θᵢ=λᵢξ_{Ji}. (8)

Taking into account the following expressions for variational derivatives:

$$\begin{matrix}{Θ}_{0} = {T}_{u}^{- 1} , & ( 9 ) \\ {Θ}_{i} = - {T}_{u}^{- 1} {κ}_{i} + \frac{δ {S}_{{D}^{*}}}{δ {n}_{i}} , & ( 10 )\end{matrix}$$

where κᵢ is the chemical potential of the corresponding component, equation (7) means that the constant temperature condition exists throughout the mixture, the system of equations (8) provides the equality of chemical potentials for each chemical component in every phase.

The motion of a mixture obeys hydrodynamic equations for chemical components, momentum and energy of the mixture. In the Cartesian coordinate system, these equations have the following forms:

∂ₜnᵢ+∂ₐ(nᵢvₐ+Qᵢₐ)=h_{I}η_{Ii}

∂ₜ(ρvₐ)+∂_{b}(ρvₐv_{b}−p_{ab})=0

∂ₜε+∂ₐ(εvₐ+qₐ+p_{ba}v_{b})=0 (11)

It is necessary to specify boundary conditions and constitutive relations, i.e. explicit expressions for diffusion flux Qᵢₐ, stress tensor p_{ab}, heat flux qₐ and the functions h_{I} determining the rate of corresponding chemical reaction.

### Boundary Conditions:

vₐ=0 is no-slip condition for the velocity at a contact with immobile solid,

lₐQᵢₐ=0 is condition of impermeability of a contact for the diffusion flux,

(s_{*,i}−Tᵤ⁻¹u_{*,i}+αᵢⱼlₐ∂ₐnⱼ)=0 is wetting condition,

∂,u*=lₐ(qₐ^{ext}−qₐ) is condition for the surface energy, (12)

where qₐ^{ext} is the vector of external heat flux from the surrounding immobile solid phase.

### Constitutive Relations:

Constitutive relations are formulated by using the appropriate models of continuous media and the particular expression of entropy in (1). In addition, the following inequalities must be fulfilled:

qₐ∂ₐΘ₀+Qᵢₐ∂ₐΘᵢ≥0 for diffusion and heat flux,

τ_{ab}∂_{b}υₐ≤0—for viscous stress tensor,

h_{I}η_{Ii}Θᵢ≥0—for rate of reaction. (13)

Examples of the constitutive relations for some particular continuous media models can be found in (Demianov A. Yu., Dinariev O. Yu., Evseev N. V. Introduction to the Density Functional Method in Hydrodynamics. Fizmatlit. Moscow. 2014. p. 69-70).

To model a reactive mixture flow it is necessary to determine η_{Ii} vector and h_{I} function. It can be done by performing experiments or by modeling chemical reactions within chemical reaction software containing extensive database on thermodynamic data for species involved to reaction, reaction rate law, parameters of reaction rate law (see Block 7).

Reaction of calcite dissolution in hydrochloric acid is considered below;

CaCO₃+2HCl=CaCl₂+CO₂+H₂O. (14)

This reaction is much faster than the contact time of the minerals with acids. In such cases, the equilibrium is achieved as soon as the reactive species reach the surface of a mineral. As this reaction is transport controlled, it is reasonable to assume that h_{I} is determined by flow rate but not determined by the specific chemical composition of a system. Given the described conditions of the reaction (14) and its usual application scenario workflow, some other assumptions can safely be made to model the reactive HCl flow through calcite in the framework of DUD with a reasonable accuracy: 1) the temperature change is small, 2) CaCl₂ and CO₂ are always fully dissolved in liquid under the specified conditions, 3) components in liquid can mix at arbitrary proportions, 4) the reaction continues until a full depletion of either CaCO₃ or HCl. Taking into account these assumption, at least 5-components 2-phase system must be considered to model calcite dissolution. The vector η can be easily determined from the stoichiometry coefficients of chemical equation (14):

ϕ={1,2,0,0,0}, ϕ′={0,0,1,1,1}, η={1,2,−1,−1,−1}. (15)

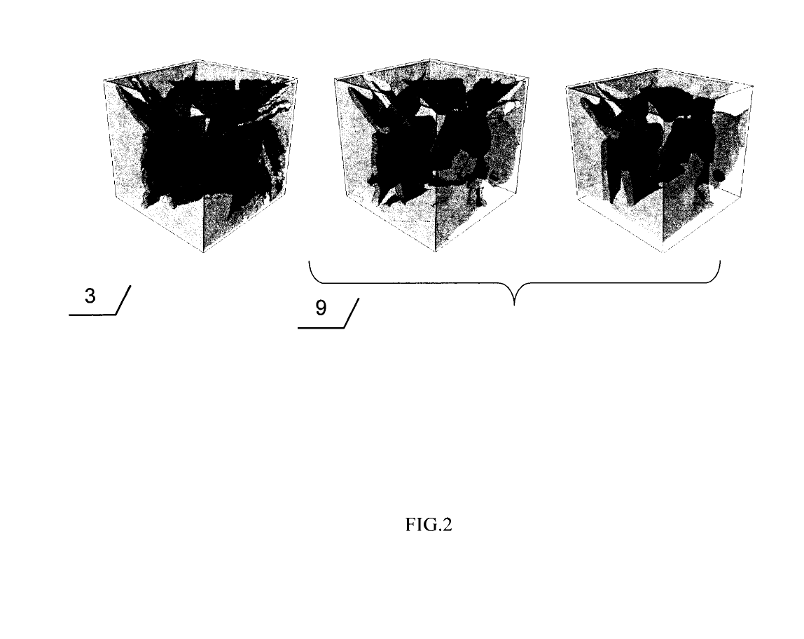

2-phase 5-component modeling of calcite dissolution in 15% solution of hydrochloric acid widely used for stimulation of carbonate reservoirs has been performed small digital rock (DR) model. Model size is 0.5×0.5×0.5 mm³, volume of fluids pumped is 1PV, the simulation time is 0.03 c. FIG. 2 demonstrates evolution of core porous structure with time caused by hydrochloric acid injection. As it is seen from the series of pictures, injection of hydrochloric acid leads to increasing of pore space in the digital rock model. As a result, permeability also increases.

In order to perform mathematical modeling, explicit values or analytical expressions that are dependent on local temperature and local molar densities may be used for the following quantities: volume and shear viscosity (or other rheological properties including effects like adsorption elongation viscosity, viscoelastisity, size exclusion effect etc.), thermal and diffusion transport coefficients, surface tension at the contact between fluid and rock and between different fluids. For these quantities, experimental values or experimentally validated correlations in respect to temperature and molar densities are used in one or more embodiments.

In order to obtain material parameters experimentally, standard and well established laboratory methods, such as mass density obtained by buoyancy or acoustic principles, may be used. Shear viscosity may be obtained from the drag force of a fluid past a surface and is also dependent on shear rate (shear rheology). Advanced rheological characterization of non-Newtonian reservoir fluids may be performed using rotary viscometers, core flooding, measurements of adsorption, flooding within channels of controlled geometry, such as microfluidic experiments, capillary viscometers, and other techniques. Pendant drop tensiometers and drop shape analysis may be used to determine the interfacial tension and contact angle between fluid/fluid and fluid/fluid/solid. Validated correlations may be obtained or derived from data reported in the openly accessible literature and/or proprietary data. Experiments may also include pressure, volume, and temperature (PVT) characterization of the reservoir fluids.

In Block 9, modified 3D pore scale models for each scenario of the chemical treatment of the at least one portion of the near wellbore area are generated. Each modified 3D pore scale model describes a pore space of the extracted core sample after the chemical treatment.

In Block 10, transport properties of the extracted core sample after the chemical treatment are calculated for each scenario of the chemical treatment of the at least one portion of the near wellbore area by performing simulation of a non-reactive fluid flow through the pore space, of the core sample after the chemical treatment using the generated modified 3D pore scale models (see Block 9). In one or more embodiments transport properties are studied in the framework of density functional theory applied for hydrodynamics (DFH).

In Block 11, comparative analysis of the simulation results is performed to select a scenario of chemical treatment of the portion of the near wellbore area. The calculated transport properties of the extracted core sample and the calculated transport properties of the extracted core sample after the chemical treatment are compared. The comparative analysis may select the scenario that provides the specified porosity, permeability and relative permeability of the core sample after the treatment.

In Block 12, a determination is made whether to consider another portion of the near wellbore areas. Specifically, core samples may be obtained from different portions of the near wellbore area. By obtaining different core samples, embodiments may account for the heterogeneity of the characteristics of the rock in the different portions of the near wellbore area. If a determination is made to consider another portion of the near wellbore area, then the flow may repeat with Block 1.

In Block 13, the selected scenarios are compared for each portions of the near wellbore area. In particular, in one or more embodiments, the comparison is performed across the scenarios that turned out to be optimal in Block 11 for each portion of the near wellbore area. In one or more embodiments, if the majority of the portions of the near wellbore area have the same corresponding chemical treatment scenery, then the optimal chemical scenery may be selected as global chemical treatment scenery for near wellbore area. If various exist, then the oilfield may be divided into parts, whereby each part includes one or more portions of the near wellbore area. Optimal chemical treatment scenario can be selected for each part of the near wellbore area. Then global chemical treatment scenario of the near wellbore area is comprised of several scenarios each of those applied to a particular part of a near wellbore area.

In Block 14, chemical treatment is performed following the global scenario of chemical treatment of the near wellbore area. In one or more embodiments, the injection operation may be performed automatically, such as by chemical treatment modeling tool sending instructions to equipment at the wellsite, or manually.

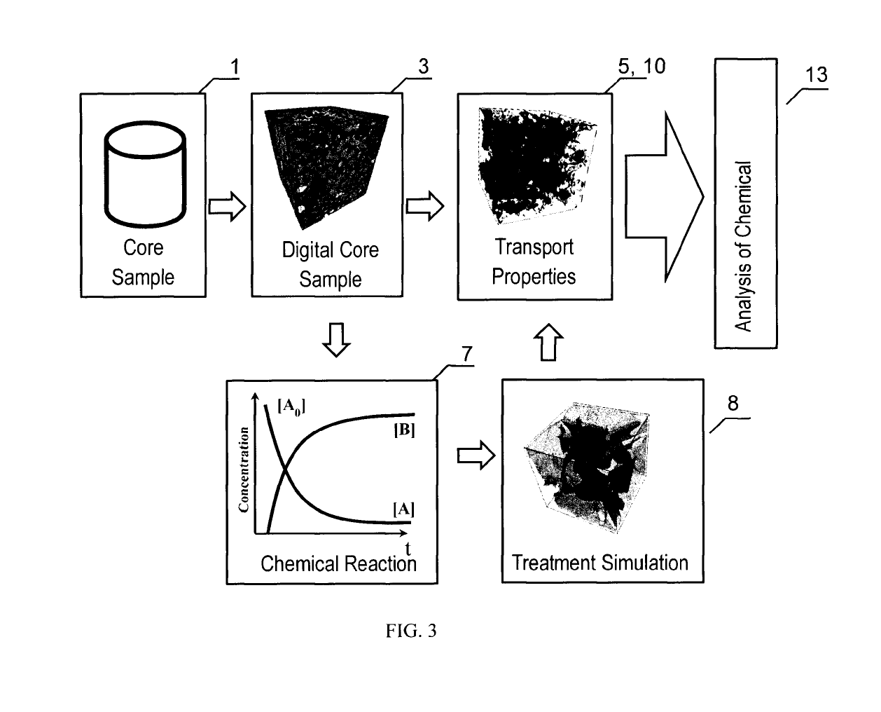

FIG. 3 shows an example diagram in accordance with one or more embodiments. The following examples are for explanatory purposes only and not intended to limit the scope of the claims. As shown in FIG. 3, a 3D core sample 1 is obtained from a near wellbore area. From the 3D core sample, a 3D pore scale model 3 is generated. A rate of a reaction between the treatment fluid and the minerals of the core sample is identified 7 and introduced to a chemical treatment simulator. Simulation 8 of a reactive fluid flow through a pore space of the core using the 3D model 3 is performed. Then simulations 5 and 10 of a non-reactive fluid flow are performed to study transport properties of the initial core sample as well as the core sample after the treatment using the 3D digital core model and the modified models generated after the treatment. Then analysis 13 of simulation results is carried out.

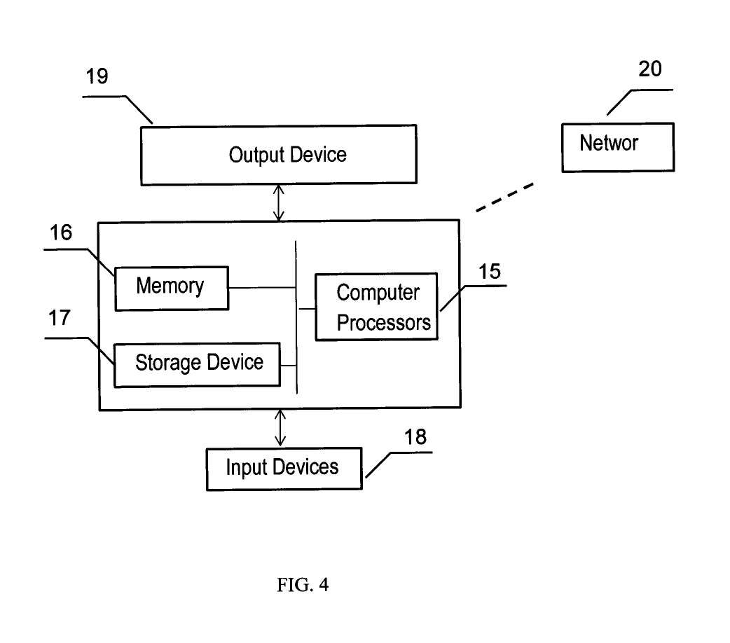

Embodiments can be implemented on any type of computing system regardless of the platform being used. For example, a computing system may be one or more mobile devices, desktop computer, server or any other type of computing device or devices that includes at least the minimum processing power, memory, and input and output devices to perform one or more embodiments. For example, as shown in FIG. 4, the computing system may include one or more computer processor(s) 15, an associated memory 16 (e.g., random access memory (RAM), cache memory, flash memory, etc.), one or more storage device(s) 17 (e.g., a hard disk, an optical drive such as a compact disk (CD) drive or digital versatile disk (DVD) drive, a flash memory stick, etc.), and numerous other elements and functionalities. The computer processor(s) 15 may be an integrated circuit for processing instructions. For example, the computer processor(s) may be one or more cores, or micro-cores of a processor. The computing system may also include one or more input device(s) 18, such as a touchscreen, keyboard, mouse, microphone, touchpad, electronic pen, or any other type of input device. Further, the computing system may include one or more output device(s) 19, such as a screen (e.g., a liquid crystal display (LCD), a plasma display, touchscreen, cathode ray tube (CRT) monitor, projector, or other display device), a printer, external storage, or any other output device. One or more of the output device(s) may be, the same or different from the input device(s). The computing system may be connected to a network 20 (e.g., a local area network (LAN), a wide area network (WAN) such as the Internet, mobile network, or any other type of network) via a network interface connection (not shown). The input 18 and output 19 device(s) may be locally or remotely (e.g., via the network) connected to the computer processor(s) 15, memory 16, and storage device(s) 17. Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments.

Further, one or more elements of the aforementioned computing system may be located at a remote location and connected to the other elements over a network. Further, embodiments may be implemented on a distributed system having a plurality of nodes, where each portion may be located on a different node within the distributed system. In one embodiment, the node corresponds to a distinct computing device. Further, the node may correspond to a computer processor with associated physical memory. The node may correspond to a computer processor or micro-core of a computer processor with shared memory and/or resources.

While the above has been described with respect to a limited number of embodiments, those skilled in the art, having benefit of this disclosure, will appreciate that other embodiments can be devised which do not depart from the scope as disclosed herein. Accordingly, the scope should be limited by the attached claims.

What is claimed is:

1. A method for performing a chemical treatment of a near wellbore area comprising:
extracting a core sample consisting of rock minerals from at least one portion of the near wellbore area;
scanning the extracted core sample and obtaining a three-dimensional (3D) porous solid image of the extracted core sample;
generating a 3D pore scale model from the obtained 3D porous solid image, wherein the 3D pore scale model describes a pore space of the extracted core sample;
determining mineral composition of the extracted core sample;
calculating transport properties of the extracted core sample by performing simulation of a non-reactive fluid flow through the pore space of the extracted core sample using the generated 3D pore scale model;
generating a plurality of scenarios of the chemical treatment of the at least one portion of the near wellbore area, each scenario providing for injection of at least one treatment fluid comprising at least one chemical agent;
for each scenario of the chemical treatment of the at least one portion of the near wellbore area defining rates of chemical reactions between the rock minerals of the extracted core sample and the chemical agents of the treatment fluids and quantitative and qualitative compositions of a reaction system in equilibrium;
for each scenario of the chemical treatment of the at least one portion of the near wellbore area performing simulation of a reactive fluid flow through the pore space of the core sample using the generated 3D pore scale model, the defined rates of the chemical reactions between the rock minerals of the extracted core sample and the chemical agents of the treatment fluids and the defined quantitative and qualitative compositions of the reaction system in equilibrium, and generating a modified 3D pore scale model for each scenario of the chemical treatment of the at least one portion of the near wellbore area, wherein each modified 3D pore scale model describes a pore space of the extracted core sample after the chemical treatment;
for each scenario of the chemical treatment of the at least one portion of the near wellbore area calculating transport properties of the extracted core sample after the chemical treatment by performing simulation of a non-reactive fluid flow through the pore space of the core sample after the chemical treatment using the generated modified 3D pore scale models;
for each scenario of the chemical treatment of the at least one portion of the near wellbore area comparing the calculated transport properties of the extracted core sample and the calculated transport properties of the extracted core sample after the chemical treatment;
selecting scenario of the chemical treatment providing specified porosity, permeability and relative permeability of the core sample after the chemical treatment; and
performing the chemical treatment of the at least one portion of the near wellbore area using the selected scenario of the chemical treatment.

2. The method of claim 1, wherein each scenario of the plurality of the chemical treatment scenarios is characterized by composition of the at least one treatment fluid comprising the at least one chemical agent, and/or number of stages of the chemical treatment, and/or sequence of injection of the treatment fluids, and/or volumes of the treatment fluids injected on each stage, and/or rates of the treatment fluid injection on each stage, and/or shut in time on each stage.

3. The method of claim 1, wherein the quantitative composition of the reaction system is determined from thermodynamic properties of species involving in the chemical reactions.

4. The method of claim 1, wherein the three-dimensional (3D) porous solid image of the extracted core sample is obtained by 3D NMR imaging.

5. The method of claim 1, wherein the three-dimensional (3D) porous solid image of the extracted core sample is obtained by 3D X-ray micro tomography.

6. The method of claim 1, wherein the three-dimensional (3D) porous solid image of the extracted core sample is obtained by 3D reconstruction from a scanning-electron microscopy image with a chemical element map obtained by energy-dispersive X-ray spectroscopy (EDX) analysis or Raman-confocal microscopy.

7. The method of claim 1, wherein the three-dimensional (3D) porous solid image of the extracted core sample is obtained by 3D reconstruction from petrographic thin-section analysis.

8. A system for performing a chemical treatment of a near wellbore area, comprising:
a computer processor, and
a chemical treatment modeling tool executing on the computer processor and comprising:
an interface configured to obtain a plurality of chemical treatment scenarios, each scenario providing for injection of at least one treatment fluid comprising at least chemical agent,
a 3D pore scale model generator configured to:
obtain a three-dimensional (3D) porous solid image of an extracted core sample consisting of rock minerals;
generate a 3D pore scale model from the obtained 3D porous solid image, wherein the 3D pore scale model describes a pore space of the extracted core sample;
a chemical treatment simulator configured to:
perform simulations of a reactive fluid flow through the pore space of the extracted core sample using the generated 3D pore scale model and rates of reactions between the rock minerals of the extracted core sample and the chemical agents of the treatment fluids,
generate modified 3D pore scale models for each scenario of the chemical treatment of the at least one portion of the near wellbore area, wherein each modified 3D pore scale model describes a pore space of the extracted core sample after the chemical treatment;
a non-reactive fluid flow simulator configured to:
perform simulation of a non-reactive fluid flow through the pore space of the extracted core sample using the generated 3D pore scale model and through the pore space of the core sample after the chemical treatment using the generated modified 3D pore scale models;
calculate transport properties of the extracted core sample and the calculated transport properties of the extracted core sample after the chemical treatment;
compare the calculated transport properties of the extracted core sample and the calculated transport properties of the extracted core sample after the chemical treatment;
select scenario of the chemical treatment providing specified porosity, permeability and relative permeability of a core sample after the chemical treatment;
wherein the chemical treatment is performed using the selected scenario.

9. The system of claim 8, wherein the chemical treatment modeling tool further comprises:
an image generator configured to generate images of the simulation results.

10. The system of claim 8, further comprising:
a data repository configured to store:
the plurality of the scenarios of the chemical treatment of the at least one portion of the near wellbore area,
the 3D pore scale model,
the generated modified 3D pore scale models,
data on the rates of reactions between the rock minerals of the extracted core sample and the chemical agents of the treatment fluids provided for by the scenarios.
data on thermodynamic properties of species.

11. (canceled)
